(19) United States
(12) Patent Application Publication
(10) Pub. No.: US 2012/0189026 A1
(43) Pub. Date: Jul. 26, 2012

(54) TUNABLE RESONATORS

(75) Inventors: Nathan Lorenzo Binkert, Redwood City, CA (US); Jung Ho Ahn, Seoul (KR); Marco Florentino, Palo Alto, CA (US)

(73) Assignee: HEWLETT-PACKARD DEVELOPMENT COMPANY, L.P., Houston, TX (US)

(21) Appl. No.: 13/259,468

(22) PCT Filed: Oct. 8, 2009
(86) PCT No.: PCT/US2009/059964

§ 371 Date: Sep. 23, 2011

(51) Int. Cl. H01S 3/11

(52) U.S. Cl. 372/20; 372/92

(57) ABSTRACT

Various embodiments of the present invention relate to electronically tunable ring resonators. In one embodiment of the present invention, a resonator structure (300,1200) includes an inner resonator disposed on a surface of a substrate, and a phase-change layer (304,1204) covering the resonator. The resonance wavelength of the resonator structure can be selected by applying of a first voltage that changes the effective refractive index of the inner resonator and by applying of a second voltage that changes the effective refractive index of the phase-change layer.

### TECHNICAL FIELD

Embodiments of the present invention relate generally to resonators.

### BACKGROUND

In recent years, resonators, such as ring and disk resonators, have increasingly been employed as components in optical networks and other nanophotonic systems that are integrated with electronic devices. A resonator can ideally be configured with a resonance wavelength substantially matching a particular wavelength of light. When a resonator is positioned adjacent to a waveguide such that the resonator is within the evanescent field of light propagating along the waveguide, the resonator evanescently couples at least a portion of the particular wavelength of light from the waveguide and traps the light for a period of time. Resonators are well-suited for use in modulators and detectors in nanophotonic systems employing wavelength division multiplexing (“WDM”). These systems transmit and receive data encoded in different wavelengths of light that can be simultaneously carried by a waveguide. Resonators can be positioned at appropriate points adjacent to the waveguide. A resonator can be configured and operated to encode information in an unmodulated wavelength of light by modulating the amplitude of the wavelength of light, and another resonator can be configured and operated to extract a wavelength of light encoding information and convert the encoded wavelength into an electronic signal for processing.

However, a resonator's dimensions directly affect the resonator's resonance wavelength, which is particularly important, because in typical WDM systems the wavelengths may be separated by fractions of a nanometer. Environmental factors affecting a resonator's resonance wavelength include low resonator temperatures due to low ambient temperature or lack of power dissipation of neighboring circuits. In addition, even with today's microscale fabrication technology, fabricating resonators with the dimensional precision that ensures the resonator's resonance wavelength matches a particular wavelength of light can be difficult. These problems arise because the resonance wavelength of a resonator is inversely related to the resonator's size. In other words, the resonance wavelength of a small resonator is more sensitive to variations in resonator size than that of a relatively larger resonator. For example, a deviation of just 10 nm in the radius of a nominally 10 μm radius resonator results in a resonance wavelength deviation of 1.55 nm from the nominal resonance wavelength for which the ring resonator was designed. This 0.1% deviation approaches the limits in accuracy for fabricating resonators using lithography. A deviation of this magnitude may be unacceptable in typical optical networks and microscale optical devices where the wavelength spacing is less than 1 nm.

### BRIEF DESCRIPTION OF THE DRAWINGS

FIG. 1 shows an isometric view and enlargement of a ring resonator and a portion of an adjacent ridge waveguide configured in accordance with embodiments of the present invention.

FIG. 2 shows an example plot of insertion loss versus wavelength for a ring resonator and adjacent waveguide in accordance with embodiments of the present invention.

FIGS. 3A-3C show three different views of an example electronically tunable ring resonator configured in accordance with embodiments of the present invention.

FIG. 4 shows an isometric view of the ring resonator, shown in FIG. 3, in electronic communication with two voltage sources in accordance with embodiments of the present invention.

FIG. 5 shows a plot of two hypothetical insertion loss curves versus wavelength for a ring resonator configured and operated in accordance with embodiments of the present invention.

FIG. 6 shows an enlarged cross-sectional view of a first implementation of the ring resonator along a line I-I, shown in FIG. 3A, configured in accordance with embodiments of the present invention.

FIGS. 7A-7C show an enlarged region of the implementation shown in FIG. 6, each Figure representing one of three solid-state phases of a phase-control layer operated in accordance with embodiments of the present invention.

FIG. 8 shows an enlarged cross-sectional view of a second implementation of the ring resonator along a line I-I, shown in FIG. 3A, configured in accordance with embodiments of the present invention.

FIGS. 9A-9C show an enlarged region of the implementation shown in FIG. 8, each Figure representing one of three solid-state phases of a phase-control layer operated in accordance with embodiments of the present invention.

FIG. 10 shows an enlarged cross-sectional view of a third implementation of the ring resonator along a line I-I, shown in FIG. 3A, configured in accordance with embodiments of the present invention.

FIG. 11A shows a plot of insertion loss versus wavelength associated with tuning a ring resonator configured and operated in accordance with embodiments of the present invention.

FIG. 11B shows a plot of insertion loss versus wavelength for a ring resonator configured in accordance with embodiments, of the present invention on resonance with a wavelength of light.

FIGS. 12A-12B show two different views of an example electronically tunable disk resonator structure configured in accordance with embodiments of the present invention.

FIG. 13 shows a cross-sectional view of a first example implementation of the ring resonator along a line III-III, shown in FIG. 12A, in accordance with embodiments of the present invention.

FIG. 14 shows a cross-sectional view of a second implementation of the disk resonator along a line III-III, shown in FIG. 12A, in accordance with embodiments of the present invention.

FIG. 15 shows a control-flow diagram summarizing operations associated with tuning a resonator structure in accordance with embodiments of the present invention.

### DETAILED DESCRIPTION

Various embodiments of the present invention relate to electronically tunable ring and disk resonators. Resonator structure embodiments of the present invention include a phase-change layer disposed over the outer surface of an inner ring or disk resonator. The solid-state phase of the phase-change layer can range from an amorphous state, where there are no long range order to the atoms and molecules comprising the phase-change layer, to a highly ordered crystalline state, where the atoms and molecules are arranged in a long range orderly repeating pattern throughout the phase-change layer. The resonance wavelength of the resonator structure can be tuned by applying a first appropriate voltage to the phase-change layer and a second appropriate voltage across the inner ring or disk.

The detailed description is organized as follows. A general description of ring resonators is provided in a first subsection. A description of ring resonator embodiments is provided in a second subsection. A description of electronically controllable ring-resonator implementations is provided in a third subsection. A description of disk resonator embodiments is provided in a fourth subsection.

### I. Ring Resonator Optical Properties

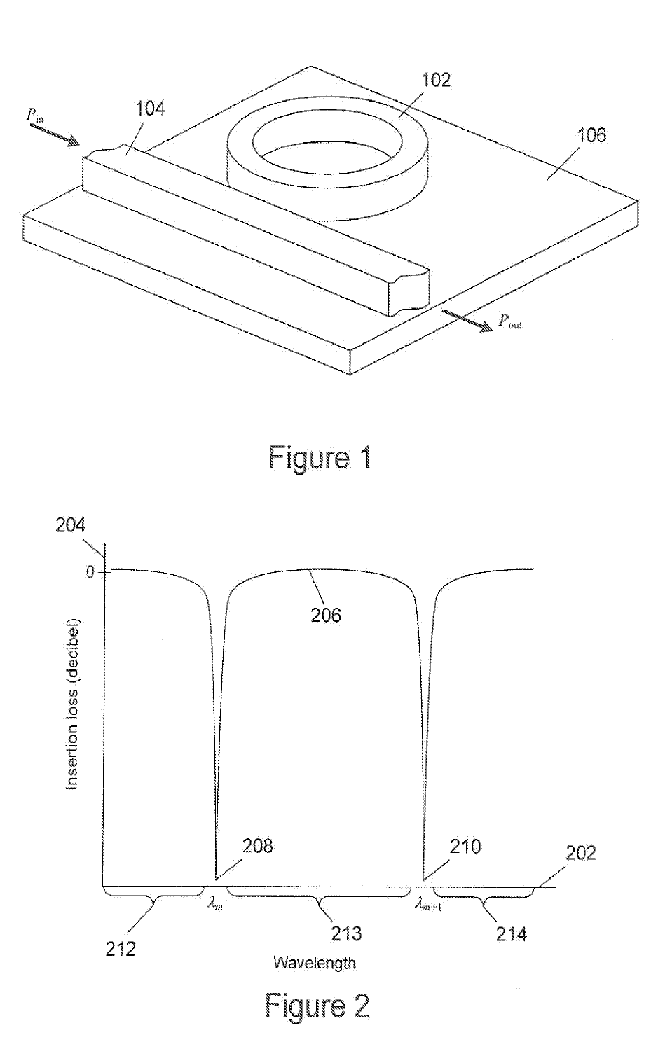

FIG. 1 shows an isometric view and enlargement of a ring resonator 102 and a portion of an adjacent ridge waveguide 104 disposed on the surface of a substrate 106 in accordance with embodiments of the present invention. The resonator 102 and the waveguide 104 are composed of a material having a relatively higher refractive index than the substrate 106. For example, the resonator 102 can be composed of silicon (“Si”) and the substrate 106 can be composed of silicon dioxide (“SiO₂”) or a lower refractive index material. Light of a particular wavelength transmitted along the waveguide 104 can be evanescently coupled from the waveguide 104 into the resonator 102 when the wavelength of the light and the dimensions of the resonator 102 satisfy the resonance condition:

$$\frac{L}{m} = \frac{λ}{{n}_{eff}}$$

where n_{eff} is the effective refractive index of the resonator 102, L is the effective optical path length of the resonator 102, m is an integer indicating the order of the resonance, and λ is the free-space wavelength of the light traveling in the waveguide 104. The resonance condition can also be rewritten as λ=Ln_{eff}/m. In other words, the resonance wavelength for a resonator is a function of the resonator effective refractive index and optical path length.

Evanescent coupling is the process by which waves of light are transmitted from one medium, such as a resonator, to another medium, such a ridge waveguide, and vice versa. For example, evanescent coupling between the resonator 102 and the waveguide 104 occurs when the evanescent field generated by light propagating in the waveguide 104 couples into the resonator 102. Assuming the resonator 102 is configured to support the modes of the evanescent field, the evanescent field gives rise to light that propagates within the resonator 102, thereby evanescently coupling the light from the waveguide 104 into the resonator 102.

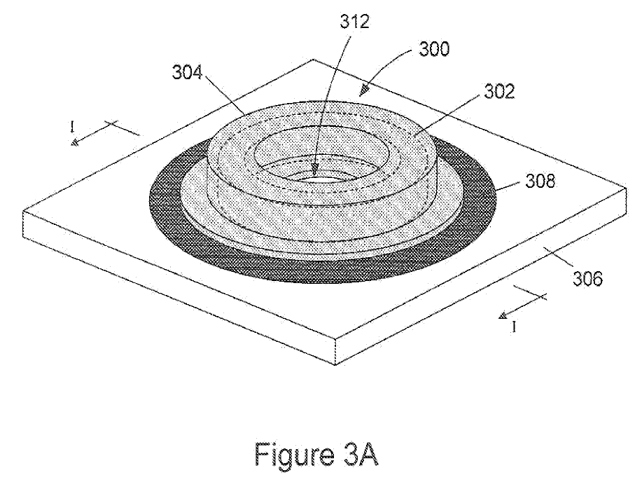

FIG. 2 shows a plot of insertion loss versus wavelength for the resonator 102 and the waveguide 104 shown in FIG. 1. Insertion loss, also called attenuation, is the loss of optical power associated with a wavelength of light traveling in the waveguide 104 coupling into the resonator 102 and can be expressed as 10 log₁₀ (Pₒᵤₜ/Pᵢₙ) in decibels (“dB”), where Pᵢₙ represents the optical power of light traveling in the waveguide 104 prior to reaching the resonator 102, and Pₒᵤₜ is the optical power of light passing the resonator 102. In FIG. 2, horizontal axis 202 represents wavelength, vertical axis 204 represents insertion loss, and curve 206 represents the insertion loss of light passing the resonator 102 over a range of wavelengths. Minima 208 and 210 of the insertion loss curve 206 correspond to wavelengths λ=Ln_{eff}/m and λₘ₊₁=Ln_{eff}/(m+1). These wavelengths represent just two of many regularly spaced minima. Wavelengths of light satisfying the resonance condition above are said to have “resonance” with the resonator 102 and are evanescently coupled from the waveguide 104 into the resonator 102. For light with wavelengths in the narrow regions surrounding the wavelengths λₘ and λₘ₊₁, the insertion loss curve 206 reveals a decrease in the insertion loss the farther wavelengths are away from the wavelengths λₘ and λₘ₊₁. In other words, the strength of the resonance between the resonator 102 and light traveling in the waveguide 104 decreases for light with wavelengths away from λₘ and λₘ₊₁. The amount of the light coupled from the waveguide 104 into the resonator 102 decreases the farther the wavelengths of light propagating with the waveguide 104 are away from λₘ and λₘ₊₁. For example, as shown in FIG. 2, light with wavelengths in the regions 212-214 pass the resonator 102 substantially undisturbed.

### II. An Overview of Ring Resonator Embodiments

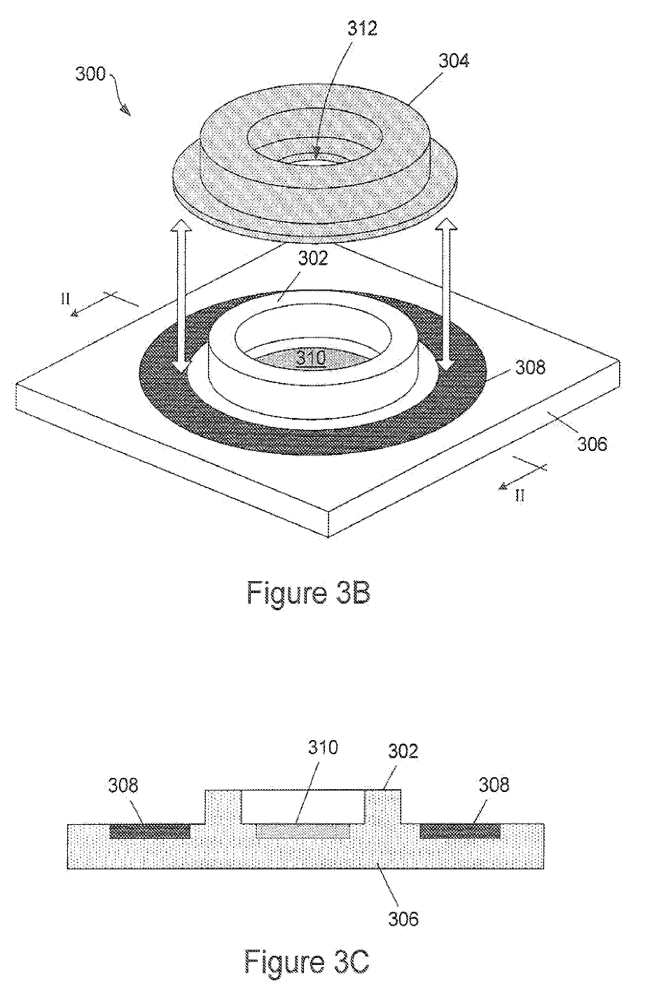

FIGS. 3A-3C show three different views of an example electronically tunable ring resonator structure 300 of the present invention. FIG. 3A shows an isometric view of the ring resonator 300. The ring resonator 300 includes an inner ring 302 and a phase-change layer (“PCL”) 304, with the PCL 304 covering the outer surface of the inner ring 302. As shown in the example of FIG. 3A, the inner ring 302 and a portion of the PCL 304 are disposed on a surface of a substrate 306. Shaded region 308 represents a doped region of the substrate 306. FIG. 3B shows an exploded isometric view of the ring resonator 300. With the PCL 304 removed, FIG. 3B reveals the inner ring 302, annular-shaped configuration of the region 308 surrounding the outside of the inner ring 302, and a second shaded region 310 representing a second doped region of the substrate 306 located within an opening of the inner ring 302. The regions 308 and 310 can be doped with different impurities as described below. FIGS. 3A and 3B also reveal an opening 312 in the PCL 304. The opening 312 leaves at least a portion of the doped region 310 exposed. FIG. 3C shows a cross-sectional view of the inner ring 302 and substrate 306 along a line II-II, shown in FIG. 3B. As shown in the example of FIG. 3C, the doped regions 308 and 310 extend into portions of the substrate 306.

The inner ring 302 and substrate 306 can be composed of a wide variety of different semiconductor materials. For example, the inner ring 302 and substrate 306 can be composed of an elemental semiconductor, such as silicon (“Si”) and germanium (“Ge”), or a III-V compound semiconductor, where Roman numerals III and V represent elements in the IIIa and Va columns of the Periodic Table of the Elements. Compound semiconductors can be composed of column IIIa elements, such as aluminum (“Al”), gallium (“Ga”), and indium (“In”), in combination with column Va elements, such as nitrogen (“N”), phosphorus (“P”), arsenic (“As”), and antimony (“Sb”). Compound semiconductors can also be further classified according to the relative quantities of III and V elements. For example, binary semiconductor compounds include semiconductors with empirical formulas GaAs, InP, InAs, and GaP; ternary compound semiconductors include semiconductors with empirical formula GaAs_{y}P_{1-y}, where y ranges from greater than 0 to less than 1; and quaternary compound semiconductors include semiconductors with empirical formula InₓGa₁₋ₓAs_{y}P_{1-y}, where both x and y independently range from greater than 0 to less than 1. Other types of suitable compound semiconductors include II-VI materials, where II and VI represent elements in the IIb and VIa columns of the periodic table. For example, CdSe, ZnSe, ZnS, and ZnO are empirical formulas of example binary II-VI compound semiconductors.

The regions 308 and 310 of the substrate 306 are doped with appropriate p-type and n-type impurities, while the inner ring 302 can be composed of an intrinsic or an undoped semiconductor. In certain embodiments, the annular-shaped region 308 can be doped with a p-type impurity, and the circular-shaped region 310 can be doped with an n-type impurity. P-type impurities can be atoms that introduce vacant electronic energy levels called “holes” to the electronic band gaps of the region 308. These impurities are also called “electron acceptors.” N-type impurities can be atoms that introduce filled electronic energy levels to the electronic band gap of the region 310. These impurities are called “electron donors.” Electron donors and electron acceptors can both be referred to as “charge carriers.” For example, boron (“B”), Al, and Ga are p-type impurities that introduce vacant electronic energy levels near the valence band of Si; and P, As, and Sb are n-type impurities that introduce filled electronic energy levels near the conduction band of Si. In III-V compound semiconductors, column VI impurities substitute for column V sites in the III-V lattice and serve as n-type impurities, and column II impurities substitute for column III atoms in the III-V lattice to form p-type impurities. The p-type region 308, intrinsic inner ring 302, and n-type region 310 form a p-i-n junction. Moderate doping of the region 308 or the region 310 can have impurity concentrations in excess of about 10¹⁵ impurities/cm³ while heavier doping of these same regions can have impurity concentrations in excess of about 10¹⁹ impurities/cm³.

Note that in other embodiments, the p-type and n-type impurities associated with the regions 308 and 310 can be reversed. For example, the region 308 can be doped with an n-type impurity and the region 310 can be doped with a p-type impurity. Also, the inner ring 302 is not limited to intrinsic material. In certain embodiments, the inner ring 302 can also be doped with impurities. For example, the inner ring 302 can be composed of Si and doped with Ge, or at least a portion of the inner ring 302 doped can be with Ge.

The PCL 304 can be composed of a solid-state phase-change material. In particular, the PCL 304 can be composed of material that can be switched into a particular solid-state phase. The solid-state phase can be placed in any state between and including an amorphous state and a crystalline state. An amorphous state is characterized by the constituent atoms and molecules having no long range order extending in all three directions of the PCL 304 material, and a crystalline state is characterized by constituent atoms and molecules arranged in an orderly repeating pattern extending in all three directions of the PCL 304 material. The PCL 304 can be placed in one of a continuum of solid-state phases between the amorphous and crystalline states by applying an appropriate stimulus, and the state is nonvolatile. In other words, once the PCL 304 is in a particular solid-state phase, the PCL 304 remains in the state until an appropriate current pulse. In certain embodiments, the PCL 304 can be composed of a chalcogenide glass, which is a semiconductor material containing one or more chalcogens, such as sulfur (“S”), selenium (“Se”), and tellurium (“Te”), in combination with relatively more electropositive elements, such as arsenic (“As”), germanium (“Ge”), phosphorous (“P”), antimony (“Sb”), bismuth (“Bi”), silicon (“Si”), tin (“Sn”), and other electropositive elements. Examples of suitable chalcogenide glasses include, but are not limited to, GeSbTe, GeSb₂Te₄, InSe, SbSe, SbTe, InSbSe, InSbTe, GeSbSe, GeSbSeTe, AgInSbTe, AgInSbSeTe, and AsₓSe₁₋ₓ, AsₓS₁₋ₓ, and As₄₀S₆₀₋ₓSeₓ, where x ranges between 0 and 1. This list is not intended to be exhaustive, and other suitable chalcogenide glasses can be used to form the PCL 304.

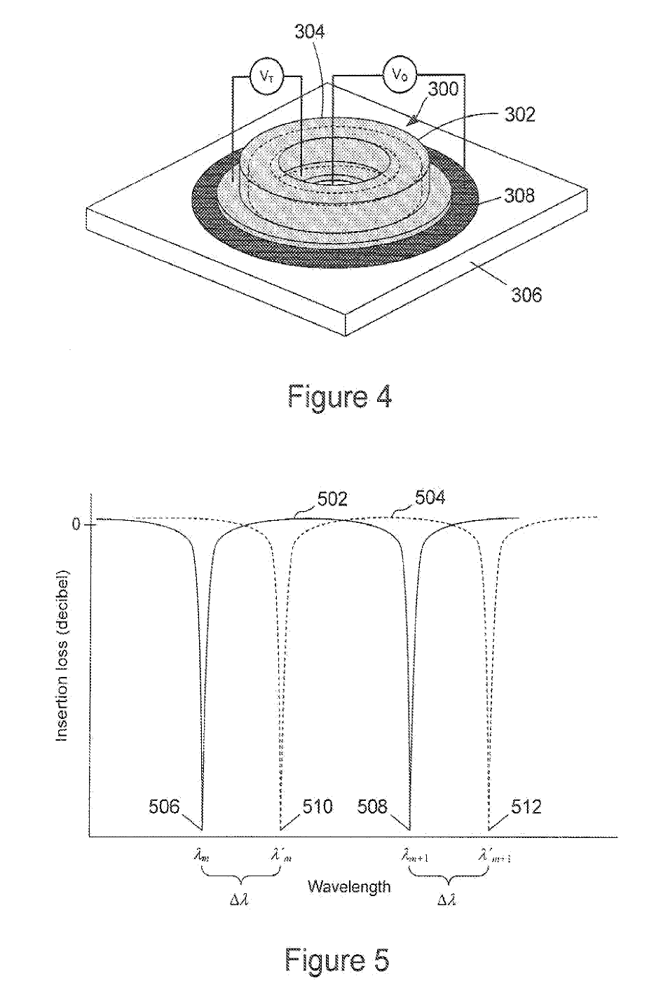

FIG. 4 shows an isometric view of the ring resonator 300 with the PCL 304 in electronic communication with a first voltage source V_{T} and the regions 308 and 310 in electronic communication with a second voltage source V_{O} in accordance with embodiments of the present invention. The voltage source V_{T} is applied for a short duration to create a current pulse through the PCL 304. The PCL 304 resistance causes the PCL 304 to heat up, changing the solid-state phase of the PCL 304. The duration of the current pulse can be used to set the solid-state phase of the PCL 304 to an amorphous state, a crystalline state, or an intermediate state, as described below. This process is referred to as “phase-change tuning” of the ring resonator 300. A change in the solid-state phase produces a corresponding change in the effective refractive index n_{eff} of the ring resonator 300. Typically, a solid material in an amorphous state has a higher refractive index than the same material in a crystalline state. For example, a solid-state phase change from the amorphous to the crystalline state of the chalcogenide glass AsSSe produces an approximate 10% refractive index reduction. According to the resonance condition, because the resonance wavelength λ is a function of the effective refractive index n_{eff}, changing the effective refractive index produces a corresponding change in the resonance wavelength of the ring resonator 300, which can be expressed as:

$$Δ λ = λ \frac{Δ {n}_{eff}}{{n}_{eff}}$$

where Δn_{eff} is the change in the effective refractive index of the material comprising the ring resonator 300. Thus, the resonance wavelength of the ring resonator 300 can be tuned by applying an appropriate voltage to the PCL 304.

The phase-change tuning provided by changing the solid-state phase of the PCL 304 alone may shift the resonance wavelength of the ring resonator 300 close to a desired resonance wavelength, such as to within a fraction of a nanometer. However, this may not be sufficient for strong evanescent coupling between the ring resonator 300 and the desired wavelength. The regions 308 and 310 and the inner ring 302 exhibit “electronic tuning” capabilities, enabling the ring resonator 300 to be more finely tuned into resonance with the desired wavelength. For electronic tuning of the ring resonator 300, the effective refractive index of the inner ring 302 can be changed, producing a corresponding change in the resonance wavelength of the ring resonator 300. As shown in the example of FIG. 4, the effective refractive index of the inner ring 302 can be changed by applying an appropriate voltage from the voltage source V_{O} to the regions 308 and 310. The polarity of the voltage supplied by the voltage source V_{O} can be a forward bias or a reverse bias, enabling the p-i-n junction formed by the regions 308 and 310 and the inner ring 302 to be operated in a forward- or a reverse-bias mode. Under a forward bias, charge carriers are injected into the inner ring 302 producing a change in the effective refractive index of the inner ring 302. Under a reverse bias, an electrical field can be formed across the inner ring 302 and an effective refractive index change can result through the electro-optic effect or charge depletion effect. Both of these electronic tuning techniques change the effective refractive index of the inner ring 302, which, in turn, produces a change in the resonance wavelength of the ring resonator 300.

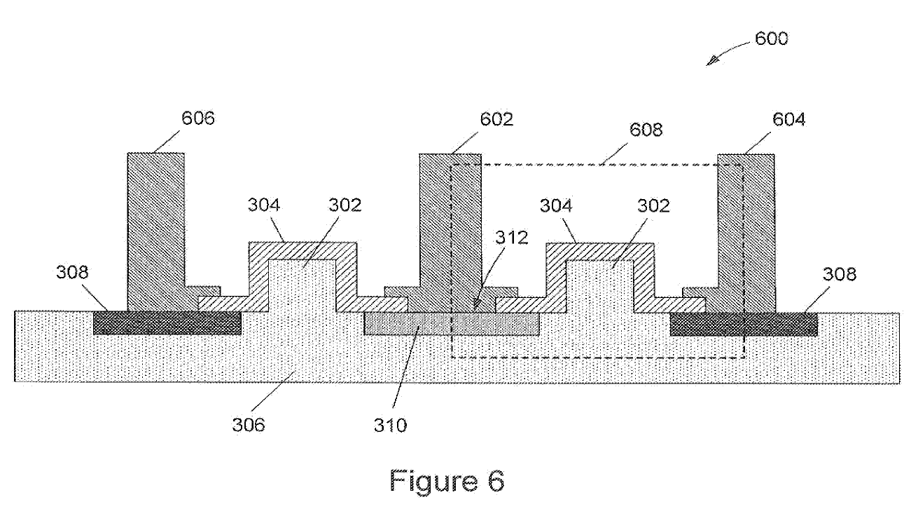

FIG. 5 shows a plot of two hypothetical insertion loss curves 502 and 504 versus wavelength for the ring resonator 300. Curve 502 represents the insertion loss for the ring resonator 300 with a first effective refractive index n_{eff}, and curve 504 represents the insertion loss for the same ring resonator 300 with a second effective refractive index to N′_{eff}. The two different effective refractive indices can be produced by phase change and/or electronic tuning. Suppose that initially the ring resonator 300 was resonant with the wavelengths λₘ, and λₘ₊₁, and after phase change and/or electronic tuning the ring resonator 300 is resonant with the wavelengths λ′ₘ and λ′ₘ₊₁. As shown in the example plot of FIG. 5, tuning shifts the resonance wavelength of the ring resonator 300 by Δλ, which shifts the insertion loss minima 506 and 508 to insertion loss minima 510 and 512, respectively. Curves 502 and 504 reveal that after tuning, light with wavelengths λₘ and λₘ₊₁ can no longer resonate within the resonator 300, but light with wavelengths and λ′ₘ and λ′ₘ₊₁ can resonate within the ring resonator 300.

Electronic tuning also provides relatively higher speed changes in the effective refractive index of the ring resonator 300 than phase-change tuning. For example, electronic tuning can be accomplished on the nanosecond and sub-nanosecond time scale, while phase-change tuning may take place on the sub-millisecond or even millisecond time scale. Thus, electronic tuning may be suitable for coding information in unmodulated light. However, electronic tuning provides tuning over a relatively limited range of wavelengths, on the order of several nanometers and is suitable for fine tuning of the resonance wavelength of the ring resonator. In order to adjust for inaccuracies in the fabrication of resonators or temperature changes due to variations in ambient temperature or lack of power dissipation of neighboring circuits, tuning over a wavelength range of at least 10-20 nm may be desirable, in which case, electronic tuning alone is not sufficient. On the other hand, phase-change tuning offers a coarser resonance wavelength tuning range than electronic tuning, although at somewhat slower speeds. Thus, phase-change tuning can be performed when needed, including after manufacturing; on a periodic basis, such as once a year, once a month, or once a week; or perhaps at system reboot.

### III. Electronically Controllable Ring Resonator Implementations

The ring resonator 300 shown in FIGS. 3A-3C represents a general ring resonator configured in accordance with embodiments of the present invention. In this subsection, a number of different ring resonator 300 implementations, including PCL 304 configurations and electrode configurations for establishing electronic communication with the PCL 304 and the regions 308 and 310 of the ring resonator 300 are provided.

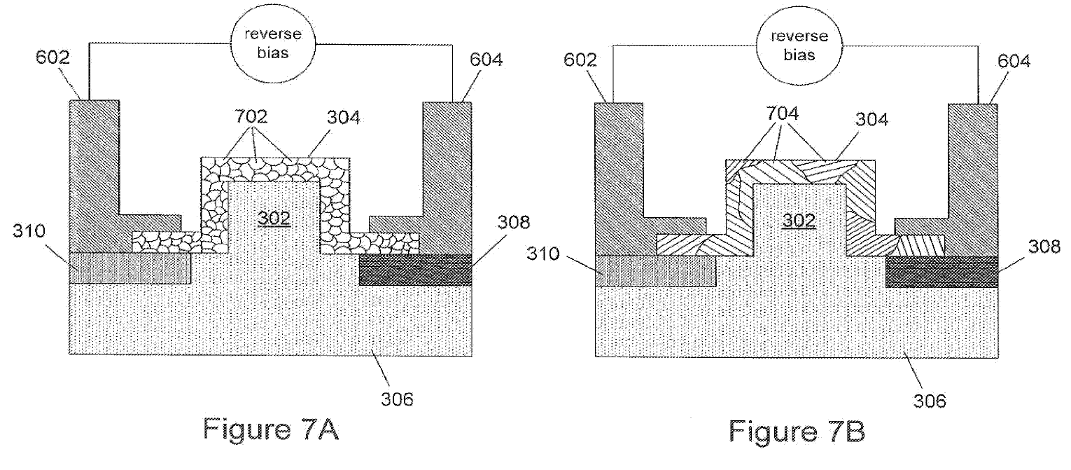

FIG. 6 shows an enlarged cross-sectional view of a first implementation 600 of the ring resonator 300 along a line I-I, shown in FIG. 3A, in accordance with embodiments of the present invention. The PCL 304 is disposed on the outer surfaces of the inner ring 302 and is disposed on at least a portion of the region 310 and at least a portion of the region 308. As shown in the example of FIG. 6, the PCL 304 includes an opening 312 through which a first electrode 602 contacts the region 310 and contacts portions of the PCL 304. The implementation 600 also includes a second electrode 604 in contact with the region 308 and an outer portion of the PCL 304 and a third electrode 606 in contact with the region 308 and an outer portion of the PCL 304, with the second and third electrodes 604 and 606 located opposite one another.

The electrodes can be composed of a conducting material, such as aluminum (“Al”), copper (“Cu”), platinum (“Pt”), silver (“Ag”), gold (“Au”), or any other suitable metallic conducting material; or the electrodes can be composed of a doped semiconductor. The two electrodes 604 and 606 are an example of the number of electrodes that can be placed in contact with the PCL 304 and the region 308. Embodiments of the present invention are not limited to two electrodes. The number of electrodes in contact with the PCL 304 and the region 308 can range from as few as one to as many as four or more, and may depend on the size of the ring resonator 300.

Electronic tuning of the ring resonator implementation 600 can be accomplished by applying a forward bias to the electrodes 602, 604, and 606 in order to induce a change in the effective refractive index of the inner ring 302 by injecting charge carriers into the inner ring 302. A forward bias can be produced by applying a positive external voltage bias to the p-type region 308 (310) relative to the bias applied to the n-type region 310 (308). On the other hand, phase-change tuning can be accomplished by applying a reverse bias to the electrodes 602, 604, and 606 in order to prevent the injection of charge carriers into the inner ring 302 and a create current pulse that effectively changes the solid-state phase of the PCL 304. A reverse bias can be produced by applying a negative external voltage bias to the p-type region 308 (310) relative to the bias applied to the n-type region 310 (308).

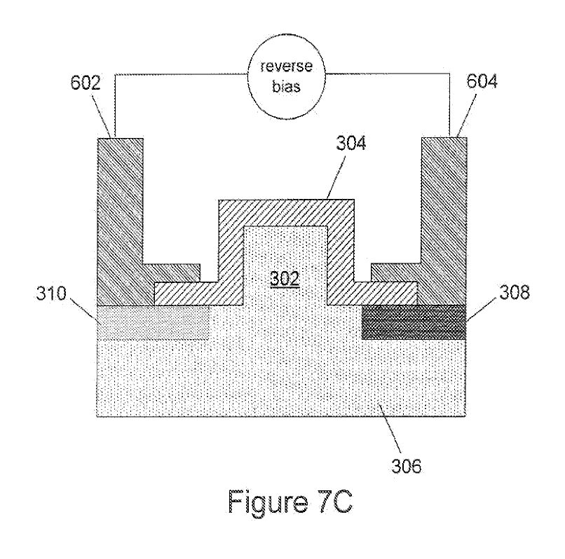

FIGS. 7A-7C show an enlarged region 608 of the implementation 600, shown in FIG. 6, with each Figure representing one of three solid-state phases of the PCL 304 in accordance with embodiments of the present invention. FIG. 7A shows an example representation of the PCL 304 in an amorphous state and corresponds to a first effective refractive index n_{eff,a} for the ring resonator 300. Subregions 702 of the PCL 304 represent very small portions of the PCL 304 where each subregion has a different arrangement of atoms and molecules comprising the amorphous state of the PCL 304. FIG. 7B shows an example representation of the PCL 304 in an intermediate solid-state phase between and including an amorphous state and a crystalline state and corresponds to a second effective refractive index n_{eff,i} for the ring resonator 300. Hash-marked subregions 704 of the PCL 304 represent portions of the PCL 304 having different crystalline states, where the atoms and molecules within each subregion may be ordered in all three directions. FIG. 7C shows an example representation of the PCL 304 in a crystalline state with a corresponding third effective refractive index n_{eff,c} for the ring resonator 300. The crystalline state corresponds to atoms and molecules substantially ordered throughout the PCL 304.

Note that the effective refractive indices n_{eff,c} and n_{eff,a} are lower and upper bounds, respectively, on the effective refractive index of the PCL 304. The effective refractive index n_{eff,i} associated with an intermediate solid-state phase falls somewhere between n_{eff,c} and n_{eff,a} (i.e., n_{eff,c}<n_{eff,i}<n_{eff,a}), where the closer the intermediate state is to the crystalline state the smaller the effective refractive index n_{eff,i}, and the closer the intermediate state is to the amorphous state the larger the effective refractive index n_{eff,i}.

Placing the PCL 304 into an amorphous state, a crystalline state, or an intermediate state can be accomplished by applying a current pulse of an appropriate duration. While the current pulse flows through the PCL 304, the resistance of the PCL material causes the PCL 304 to heat up and the atoms and molecules comprising the PCL 304 to reorganize. The initial solid-state phase and duration of the current pulse may determine which solid-state phase the PCL 304 ends up in. Consider switching the PCL 304 back and forth between the amorphous state, shown in FIG. 7A, and the crystalline state, shown in FIG. 7C. Suppose the PCL 304 is initially in the amorphous state, shown in FIG. 7A. The duration t_{a→c} of the current pulse flowing through the PCL 304 can be selected so that atoms and molecules comprising the PCL 304 have sufficient time to reorganize into the crystalline state shown in FIG. 7C. On the other hand, when the PCL 304 is initially in the crystalline state, the current pulse used to switch from the crystalline state to the amorphous state has a relatively shorter duration t_{c→a}, where t_{c→a}<t_{a→c}. The PCL 304 heats up and the atoms and molecules become disorganized, but because the duration t_{c→a} is short, the atoms and molecules do not have sufficient time to reorganize back into the crystalline state. As a result, the atoms and molecules can be reorganized to produce the amorphous state shown in FIG. 7A. In switching the PCL 304 from the amorphous state to an intermediate state, the duration t_{a→i} of the current pulse may be shorter than the duration t_{a→c}. In switching the PCL 304 from the crystalline state to an intermediate state, the duration t_{c→i} of the current pulse may be longer than the duration t_{c→a}. The duration of the current pulses can be on the order of milliseconds. For example, switching the PCL 304 from the amorphous phase state into the crystalline state may take approximately 20 ms, while switching from the PCL 304 from the crystalline state into the amorphous state may take approximately 10 ms.

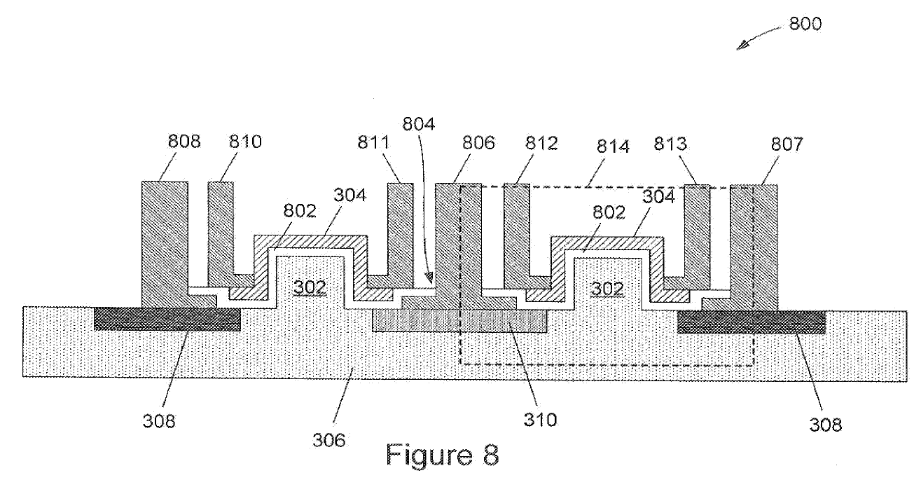

FIG. 8 shows an enlarged cross-sectional view of a second implementation 800 of the ring resonator 300 along a line I-I, shown in FIG. 3A, in accordance with embodiments of the present invention. In this embodiment, an insulating layer 802 is disposed between the PCL 304 and the inner ring 302 separating the PCL 304 from the inner ring 302 and from the regions 308 and 310. As shown in the example of FIG. 8, the implementation 800 includes two sets of electrodes. The first set, of electrodes 806-807 are used for electronic tuning. The insulating layer 802 includes an opening 804 through which the electrode 806 contacts the region 310. The second and third electrodes 604 and 606 contact the region 308. Note that unlike the implementation 600, shown in FIGS. 6-7, the insulating layer 802 prevents the electrodes 806-807 from contacting the PCL 304. The second set of electrodes comprises two pairs of electrodes that are used for phase-change tuning. The first pair of electrodes 810 and 811 are located opposite the second pair of electrodes 812 and 813.

The insulating layer 802 can be composed of SiO₂, Al₂O₃, or another suitable insulating material. The electrodes of the first and second sets of electrodes can be composed of a metallic conducting material or a doped semiconductor, as described above with reference to FIG. 6. The number of electrodes in the first set of electrodes in contact with the region 308 can range from as few as one to as many as four or more, depending on the size of the ring resonator 300. The number of pairs of second set electrodes in contact with the PCL 304 can range from a single pair of electrodes, such as single pair of electrodes 812 and 813, to four or more pairs of electrodes.

Electronic tuning of the ring resonator implementation 800 can be accomplished by applying a forward bias to the electrodes 806-808 in order to induce a change in the effective refractive index of the inner ring 302 by charge carrier injection, as described above with reference to FIG. 6. On the other hand, phase-change tuning can be accomplished by applying a bias such that the interior electrodes 811 and 812 of each pair receive the same negative or positive portion of the applied bias relative to the exterior electrodes 810 and 813.

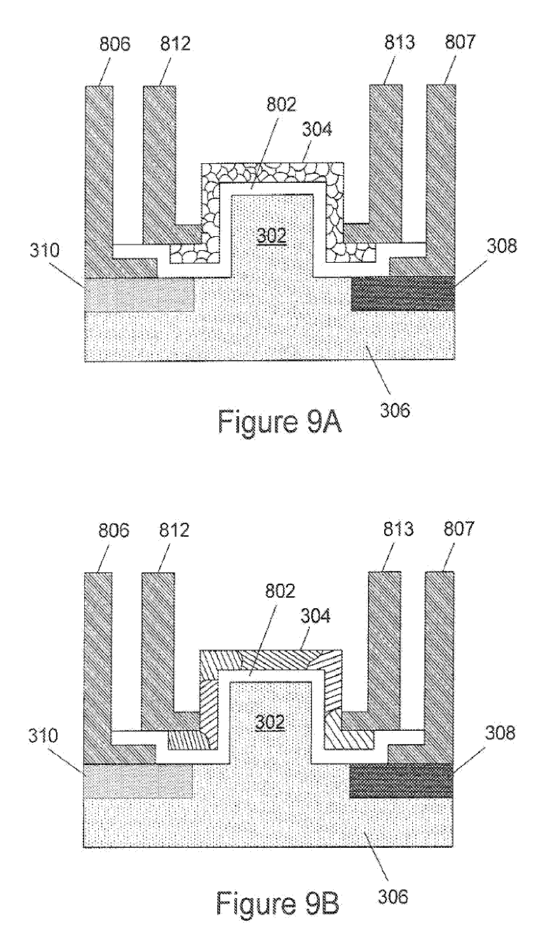

FIGS. 9A-9C show an enlarged region 814 of the implementation 800, shown in FIG. 8, with each Figure representing one of three solid-state phases of the PCL 304 in accordance with embodiments of the present invention. FIG. 9A shows an example representation of the PCL 304 in an amorphous state and corresponds to a first effective refractive index n_{eff,a} for the ring resonator 300. FIG. 9B shows an example representation of the PCL 304 in an intermediate solid-state phase between and including an amorphous state and a crystalline state and corresponds to a second effective refractive index n_{eff,i} for the ring resonator 300. FIG. 9C shows an example representation of the PCL 304 in a crystalline state with a corresponding third effective refractive index n_{eff,c} for the ring resonator 300.

The PCL 304 can be switched into an amorphous state, a crystalline state, or an intermediate state according to the duration of the current pulse applied to the PCL 304. The current pulse is created by applying an appropriate voltage to the electrodes 812 and 813. The initial solid-state phase and duration of the current pulse may determine which solid-state phase the PCL 304 ends up in, as described above with reference to FIG. 7.

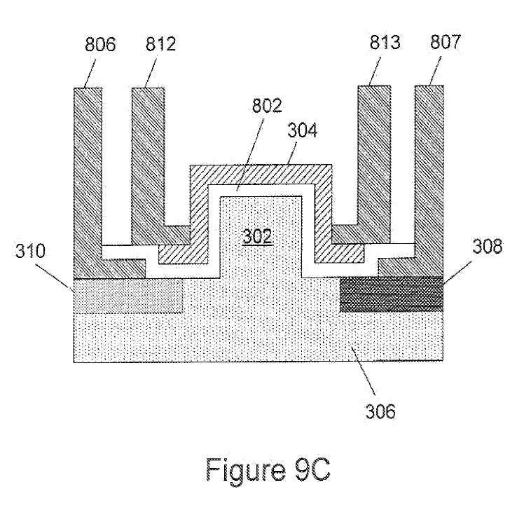

FIG. 10 shows an enlarged cross-sectional view of a third implementation 1000 of the ring resonator 300 along a line I-I, shown in FIG. 3A, in accordance with embodiments of the present invention. The implementation 1000 is substantially the same as the second implementation 800, shown in FIG. 8. In particular, returning to FIG. 8, the electrodes 806-808 contact the regions 308 and 310 on the same side of the ring resonator 300 as the second set of electrodes 810-813. By contrast, as shown in the example of FIG. 10, electrodes 1002-1004 used for electronic tuning contact the regions 308 and 310 through vias in the substrate 306 opposite the second set of electrodes 810-813.

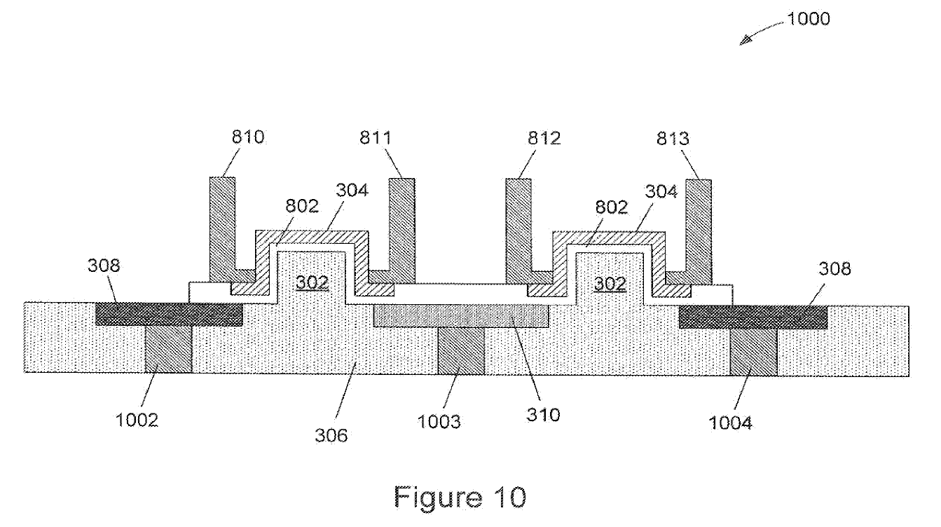

FIG. 11A shows a plot of insertion loss versus wavelength associated with tuning the ring resonator 300 in accordance with embodiments of the present invention. FIG. 11B shows a plot of insertion loss versus wavelength for the ring resonator 300 on resonance with a wavelength λ represented by dashed line 1102 (also shown in FIG. 11A). In the example plot of FIG. 11A, dot-dashed curve 1104, solid curve 1106, and dotted curve 1108 each represent the insertion loss of the resonator 602 for different effective refractive indices of the ring resonator 300. Points 1110, 1112, and 1114 correspond to where curves 1104, 1106, and 1108 intersect dashed line 1102 and represent the associated insertion losses for the wavelength λ, with the point 1112 corresponding to the largest relative insertion loss, the point 1114 corresponding to the smallest relative insertion loss, and the point 1110 corresponding to an intermediate insertion loss. In each of these cases, the amount of light extracted by the ring resonator 300 can be examined and a tuning state corresponding to a particular electronic tuning voltage and/or current pulse duration can be applied to the inner ring 302 and the PCL 304 to shift the effective refractive index of the ring resonator 300. For example, shifting the curve 1106 to substantially match the curve 1116 may use a relatively small electronic tuning whereas shifting the curve 1108 to substantially match the curve 1116 may use a substantially larger electronic tuning signal and a current pulse to change the solid-state phase of the PCL 304.

### IV. Disk Resonator Embodiments and Implementations

Embodiments of the present invention are not limited to ring resonators described above in subsections I-III and also include disk resonators that can be operated in the same manner. Disk resonators have many of the same resonance properties described above with reference to ring resonators. In particular, disk resonators can also be configured with a diameter and effective refractive index that enables the disk resonator to support resonance with particular wavelengths of light.

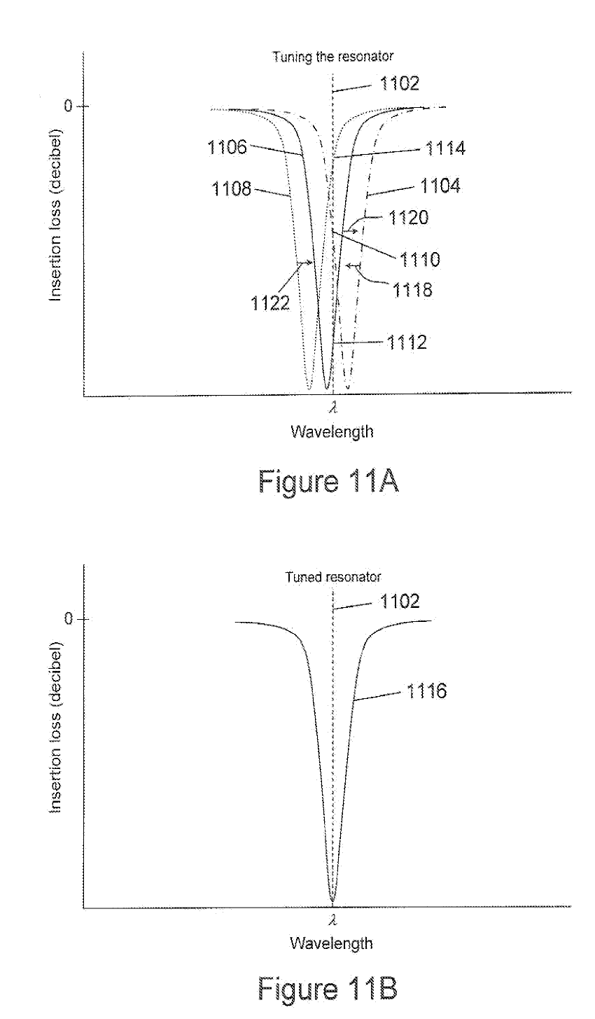

FIGS. 12A-12B show two different views of an example electronically tunable disk resonator structure 1200 of the present invention. FIG. 12A shows an isometric view of the disk resonator 1200. The disk resonator 1200 includes an inner disk 1202 and a PCL 1204, with the PCL 1204 covering the outer surface of the inner disk 1202. As shown in the example of FIG. 12A, the inner disk 1202 and a portion of the PCL 1204 are disposed on a surface of a substrate 1206. As shown in the example of FIG. 12A, the shaded region 1208 can be annular shaped around the periphery of the inner disk 1202 and represents a doped region of the substrate 1206. FIG. 12B shows a cross-sectional view of the ring resonator 1200 and substrate 1206 along a line shown in FIG. 12A. As shown in the example of FIG. 12B, the inner disk 1202 includes a doped region 1210 and doped region 1208 extends into the substrate 1206.

The regions 1208 and 1210 can be doped with appropriate p-type and n-type impurities, while the inner disk 1202 can be composed of an intrinsic or an undoped semiconductor. In particular, the inner disk 1202 and substrate 1206 can be composed of the same materials described above for the inner ring 302 and substrate 306. In certain embodiments, the annular-shaped region 1208 can be doped with a p-type impurity, and the region 1210 can be doped with an n-type impurity. In other embodiments, the region 1208 can be doped with an n-type impurity and the region 1210 can be doped with a p-type impurity. Also, the inner disk 1202 is not limited to intrinsic materials. In certain embodiments, the inner disk 1202 can also be doped with impurities, as described above for the inner ring 302. The PCL 1204 can be composed of a solid-state phase-change material. In particular, the PCL 1204 can be composed of material that can be switched into any state between and including an amorphous state and a crystalline state. In certain embodiments, the PCL 1204 can be composed of a chalcogenide glass, as described above for the PCL 304.

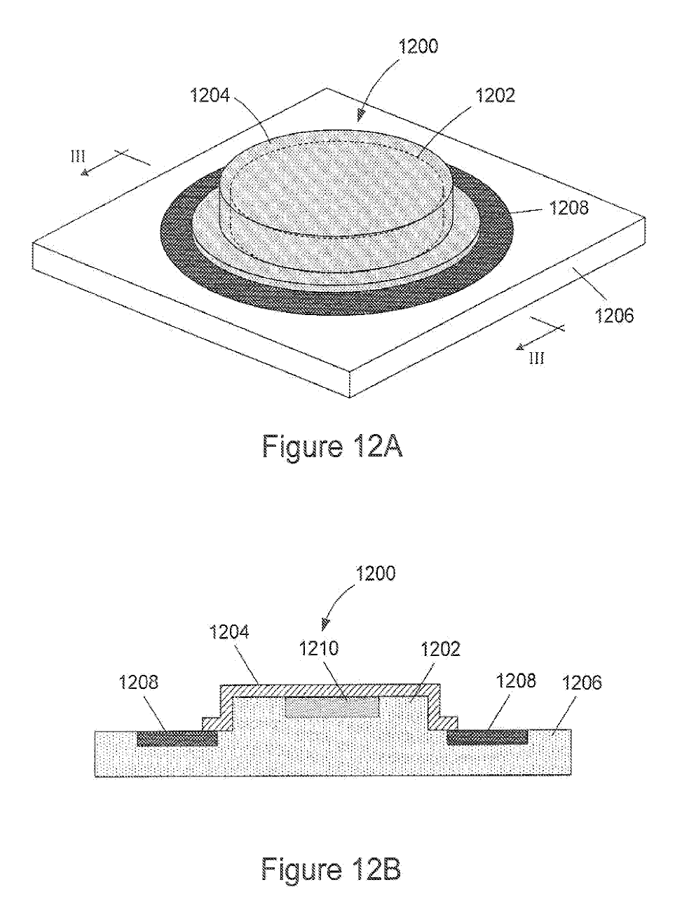

The disk resonator 1200 represents a general disk resonator configured in accordance with embodiments of the present invention. The disk resonator 1200 can be implemented in a number of different ways. FIG. 13 shows a cross-sectional view of a first example implementation 1300 of the ring resonator 1200 along a line III-III, shown in FIG. 12A, in accordance with embodiments of the present invention. As shown in the example of FIG. 13, the PCL 1204 includes an opening 1302 through which a first electrode 1304 contacts the region 1210 and contacts portions of the PCL 1204. The implementation 1300 also includes a second electrode 1306 in contact with the region 1208 and an outer portion of the PCL 1204 and a third electrode 1308 in contact with the region 1208 and an outer portion of the PCL 1204, with the second and third electrodes 1306 and 1308 located opposite one another.

The electrodes can be composed of a conducting material. The two electrodes 1306 and 1308 are an example of the number of electrodes that can be placed in contact with the PCL 1204 and the region 1208. Embodiments of the present invention are not limited to two electrodes. The number of electrodes in contact with the PCL 1204 and the region 1208 can range from as few as one to as many as four or more, and may depend on the size of the disk resonator 1200.

Electronic tuning of the ring resonator implementation 1300 can be accomplished by applying a forward bias to the electrodes 1304, 1306, and 1308 in order to induce a change in the effective refractive index of the inner disk 1202 by injecting charge carriers into the inner disk 1202. A forward bias can be produced by applying a positive external voltage bias to the p-type region 1208 (1210) relative to the bias applied to the n-type region 1210 (1208). On the other hand, phase-change tuning can be accomplished by applying a reverse bias to the electrodes 1304, 1308, and 1310 in order to prevent the injection of charge carriers into the inner disk 1202 and create a current pulse that effectively changes the solid-state phase of the PCL 1204. A reverse bias can be produced by applying a negative external voltage bias to the p-type region 1208 (1210) relative to the bias applied to the n-type region 1210 (1208).

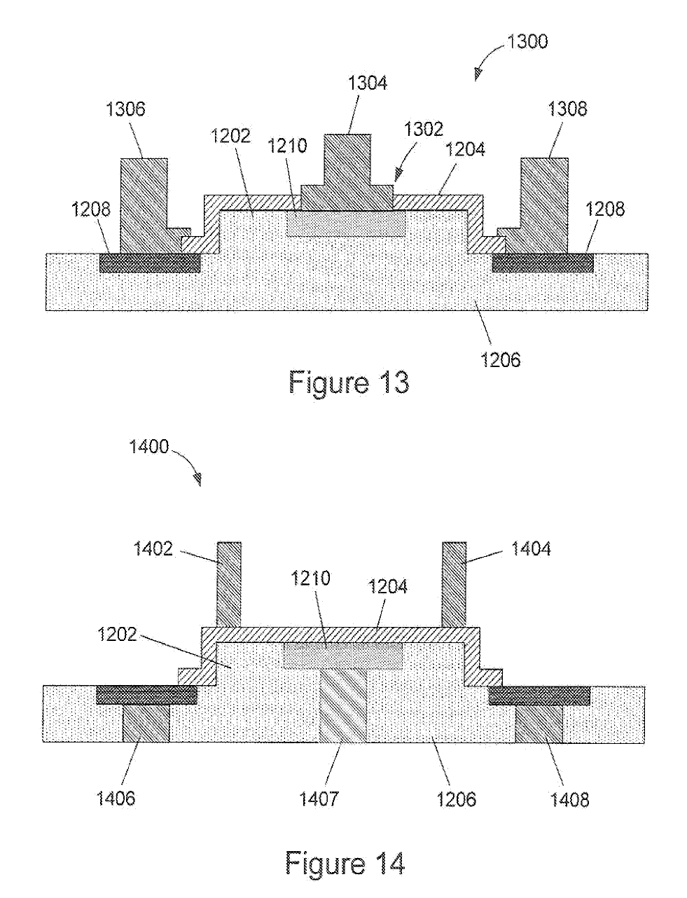

FIG. 14 shows a cross-sectional view of a second implementation 1400 of the disk resonator 1200 along a line III-III, shown in FIG. 12A, in accordance with embodiments of the present invention. As shown in the example of FIG. 14, the implementation 1400 includes a first set of electrodes 1402 and 1404 in contact with the PCL 1204 and a second set of electrodes 1406-1408, where the electrodes 1406 and 1408 contact the annular region 1408 and the electrode 1407 contacts the region 1210 through vias in the substrate 1206. The electrodes 1402 and 1404 provide phase-change tuning of the PCL 1204, and the electrodes 1406-1408 are used for electronic tuning of the inner disk 1202, as described above.

In other embodiments, the resonator structure 1200 can also include an insulating layer between the PCL 1204 and inner disk 1202, as described above, in order to insulate the PCL 1204 from inner disk 1202 during electronic and phase-change tuning.

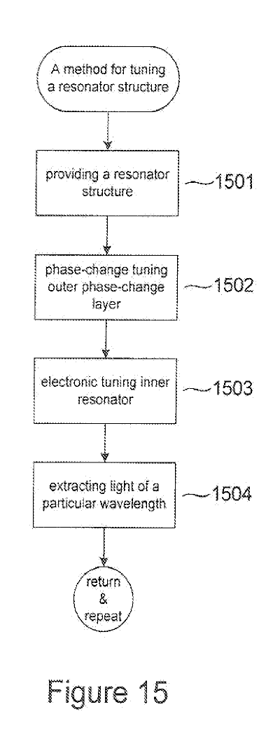

FIG. 15 shows a control-flow diagram summarizing operations associated with tuning a resonator structure in accordance with embodiments of the present invention. In step 1501, a resonator structure, such as the resonator structures 300 and 1200, is provided. The resonator structure includes an inner resonator, such as an inner ring or an inner disk, and a PCL. In step 1502, the resonator structure can be coarse tuned to within a range of wavelengths using phase-change tuning, as described above with reference to FIG. 5. Step 1502 can be performed when needed, including after manufacturing; on a periodic basis, such as once a year, once a month, or once a week; or perhaps at system reboot. In step 1503, the resonance structure can be finely tuned to narrow the range of wavelengths having resonance with the resonator structure, as described above with reference to FIGS. 5, 11A, and 11B. In step 1504, when the resonator structure is appropriately tuned, the resonator structure can extract light with a wavelength having resonance with the resonator structure from an adjacent waveguide via evanescent coupling.

The method represented in FIG. 15 can be encoded in a computer program, implemented on a computing device, and stored in a computer readable medium. The computer readable medium can be any suitable medium that participates in providing instructions to a processor for execution. For example, the computer readable medium can be non-volatile media, such as firmware, an optical disk, a magnetic disk, or a magnetic disk drive; volatile media, such as memory; and transmission media, such as coaxial cables, copper wire, and fiber optics.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A resonator structure (300,1200) comprising:
an inner resonator disposed on a surface of a substrate; and
a phase-change layer (304,1204) covering the inner resonator, wherein a resonance wavelength of the resonator structure can be selected by application of a first voltage to change the effective refractive index of the inner resonator and by application of a second voltage to change the effective refractive index of the phase-change layer.

2. The resonator structure of claim 1 wherein the inner resonator further comprising an inner ring (302).

3. The resonator structure of claim 2 further comprising a first doped region (310) located in the substrate within an opening of the inner ring and a second doped region (308) located outside the inner ring and within the substrate.

4. The resonator structure of claim 1 wherein the inner resonator further comprises an inner disk (1202) configured with second doped region within the inner disk.

5. The resonator structure of claim 4 further comprising a first doped region (1210) located in the inner disk and a second doped region (1208) located outside the inner disk and within the substrate.

6. The resonator structure of claim 1 wherein phase-change layer further comprises a chalcogenide glass.

7. The resonator structure of claim 1 wherein the effective refractive index of the phase-change layer corresponds to a particular solid-state phase of the phase-change layer material, the solid-state phase can be an amorphous state and a crystalline state or any state between an amorphous state and a crystalline state.

8. The resonator structure of claim 1 further comprising a set of electrodes (602,604,606) configured to apply the first voltage that changes the effective refractive index of the inner resonator and configured to apply the second voltage that changes the effective refractive index of the phase-change layer.

9. The resonator structure of claim 1 further comprising:
a first set of electrodes (806,808,810) configured to apply the first voltage that changes the effective refractive index of the inner resonator; and
a second set of electrodes (810-813) configured to apply the second voltage that changes the effective refractive index of the phase-change layer

10. The resonator structure of claim 1 further comprising an insulating layer (802) disposed between the phase-change layer and the inner resonator.

11. The resonator structure of claim 1 wherein the insulating layer further comprises at least one of SiO₂ and Al₂O₃.

12. A method for tuning a resonator structure, the method comprising:
providing a resonator structure (1501) including an inner resonator disposed on a surface of the substrate, and a phase-change layer (304, 1204) covering the resonator;
applying a first voltage (1502) to change a solid-state phase of the phase-change layer; and
applying a second voltage (1503) to change the effective refractive index of the inner resonator, wherein the solid-state phase of the phase-change layer and the effective refractive index of the inner resonator enables light a particular wavelength to resonate within the resonator structure.

13. The method of claim 12 wherein applying the first voltage further comprises applying a reverse bias to the phase-change layer.

14. The method of claim 12 wherein applying the second voltage further comprises applying a forward bias to the inner resonator.

15. The method of claim 12 further comprises extracting light of particular wavelength from a waveguide (1504).
